(19) United States
(12) Patent Application Publication
(10) Pub. No.: US 2005/0017985 A1
(43) Pub. Date: Jan. 27, 2005

(54) Method of creating and processing page layouts incorporating images

(75) Inventors: Ronald Wrenholt, Chanhassen, MN (US); Glenn Bottomly, Fridley, MN (US); Yusup Hartato, Shakopee, MN (US); Vincent Dominguez, St. Paul, MN (US); Kanwal Kumar, Eagan, MN (US); Wilianto Widjaja, St. Paul, MN (US); Cherry Fan, Edina, MN (US); Thang Huynh, Brooklyn Park, MN (US)

Correspondence Address: NIKOLAI & MERSEREAU, P.A., 900 SECOND AVENUE SOUTH, SUITE 820, MINNEAPOLIS, MN, 55402, US

(73) Assignee: Lifetouch, Inc., Eden Prairie, MN (US)

(21) Appl. No.: 10/624,209

(22) Filed: Jul. 22, 2003

(51) Int. Cl. G09G 5/00

(52) U.S. Cl. 345/619

(57) ABSTRACT

Page layouts are created on a computer using low-resolution versions of image files stored on a production computer system. The page layouts are then transferred to the production computer system and the low-resolution versions of the image files are automatically replaced by the high-resolution versions. Cropping and scaling of the images used in creating the page layouts are retained when the low-resolution version is replaced by the high-resolution version.

### BACKGROUND OF THE INVENTION

I. Field of the Invention

The present invention relates to the use of computers in the publication field. More particularly, the present invention relates to the electronic transfer of photographs and other images as well as the transfer of page layouts between computers.

II. Background of the Prior Art

From the invention of the printing press to relatively recent times, page layout and the printing of pages have been a manual and a mechanical task. With the advent of digital computers and printers that can be controlled by such computers, page layout and printing has been performed electronically with increasing regularity.

Given the current state of the art in the field of electronic page layout and publishing, two issues commonly arise. First, desktop publishing software products tend to require large quantities of computer memory and storage. This problem is exacerbated when the pages to be published include graphic elements such as photographs. JPEG and other file formats used to store photographs and other graphical images in a digital form tend to be very large. As a general rule, better resolution requires larger files. A high resolution photograph taken with a four mega-pixel digital camera will often result in a JPEG image file requiring well over a megabyte of storage. Similar file sizes exist when photographs and graphical images are digitized through the use of a scanner. Second, even if the computer used to create the layouts has enough memory and storage to handle the software and photos, electronically conveying completed page files including photos from one computer to another across a network such as an Internet can be a difficult and time-consuming task. These problems are particularly significant in the field of yearbook publishing. In yearbook publishing, pages including twenty or more photographs are common.

These problems are so acute that it is now standard practice in the yearbook publishing business for the yearbook publisher to store the portrait photographs it takes for use in a yearbook-on one or more CD-ROM disks and then ship these disks by regular mail to the institution (such as a school) sponsoring the yearbook. The institution then uses the files stored on these disks to create page layouts for the yearbook. The page layouts are also stored on CD-ROM disks and the disks are forwarded to the publishers for further processing and printing. This process builds significant delays into the publication of yearbooks. Also, the institution must have computers with significant storage, memory and processing power to create the page layouts given the requirements of the software used and the size of the twenty or more photo files that are often required to create a single page.

### SUMMARY OF THE INVENTION

In view of the foregoing, the object of the present invention is to provide a system and method for reliable, high-speed electronic transfer of digital files representing pictures over a computer network such as the Internet. Such electronic transfer can be either from a publisher to an institution or from the institution to the publisher.

Another object of the invention is to use pictures transferred in this fashion to design pages to be included in a publication. Still another object of the invention is to automatically and accurately print pages at a publishing plant including such photographs. The present invention meets these objectives by providing an easy-to-use mechanism for the electronic transfer of such files.

To take advantage of the present invention in a yearbook publishing environment, there must be two computers connected to the Internet-one at the location of the institution sponsoring the yearbook and another operated by the yearbook publisher. The publisher's computer can be located at the publishing plant or any other facility deemed to be advantageous by the publisher. The Internet connection makes it possible-for the two computers to exchange data.

When the present invention is used, an electronic photo library is created on the publisher's computer. Each photograph in the library is represented by an electronic file that digitally captures the photograph. Photographs included in the library can come from virtually any source. Typically, the photographs are taken by either professional photographers employed by the publisher, professional photographers employed by the institution sponsoring the yearbook, or members of the yearbook staff. The photographs can be taken using a digital camera. Alternatively, photographs can be taken using a film camera. When a film camera is used, prints are made and then scanned using a scanner to create an electronic file.

When the school or other institution sponsoring the yearbook wishes to create a page layout, it can use its computer and the Internet connection to select and retrieve photographs from the library residing on the publisher's computer. The photographs selected and retrieved can be cropped, scaled and inserted into page layouts. To streamline the size of the photographic files transferred and increase the speed and reliability of the transfer process, the photographic files actually retrieved are not the high-resolution photo files saved on the publisher's computer, but rather a low-resolution version of those files. The low-resolution versions are adequate for viewing and use in the creation of page layouts, but are not adequate for printing the yearbook.

When the page layouts are complete, they can be transferred from the institution's computer to the publisher's computer over the Internet. Alternatively, the institution can capture the file on any portable media and have such media delivered to the publisher. The page layouts transferred contain the low-resolution versions of photos to speed the transfer process and increase its reliability. After the layouts are received by the publisher's computer, the high-resolution version of each photograph used in the page layout are automatically substituted for the low-resolution versions before the page is actually printed. Any cropping, editing, scaling or the like performed on the low-resolution version of the photos using the institution's computer are automatically applied to the high-resolution version by the publisher's computer. Thus, the pages printed using the high-resolution version of the photographs match perfectly the layout created by the institution using the low-resolution version of the photos.

The various advantages of the present invention will become clear from a reading of the following detailed description of the invention in light of the accompanying drawings. This description is not intended to be limiting. The scope of the invention is defined, instead, by the claims.

### BRIEF DESCRIPTION OF THE DRAWINGS

FIG. 1 is a schematic diagram of the system employed to practice the invention.

FIG. 2 is a flow chart describing the process of the present invention.

### DETAILED DESCRIPTION OF THE PREFERRED EMBODIMENT

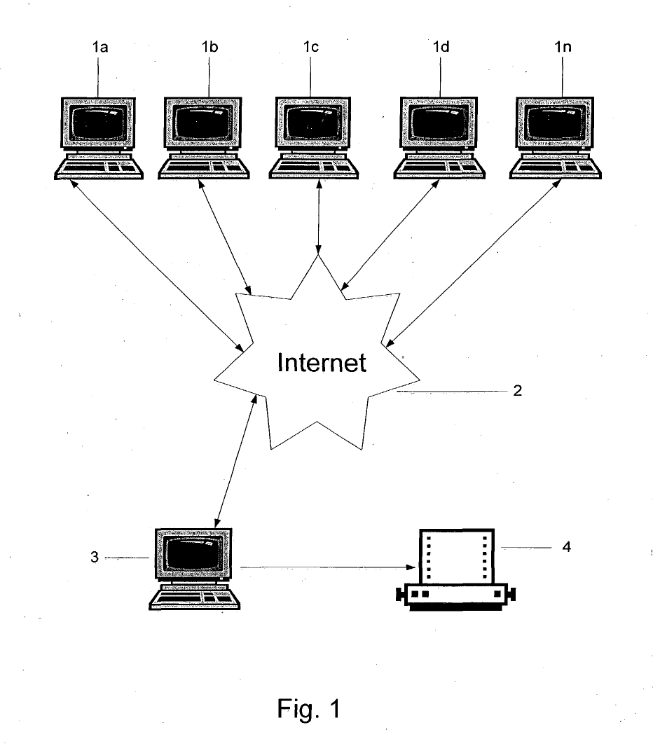

FIG. 1 shows a plurality of institutions each having computers 1a-1n connected to the Internet 2. Also connected to the Internet 2 is a computer system 3 operated by the yearbook publisher located at its publishing plant or any other location deemed appropriate by the publisher. The computer system 3 is also connected to a printer 4. The present invention contemplates that an institutional computer 1 will be used to design page layouts using pictures or other graphics stored as image files in a library on computer system 3 and that the printer 4 is used to actually print the pages of the publication designed using one of the institutional computers 1. The images, text and graphics included in the page layout can be drawn from any source and captured electronically in the library. To simplify the discussion contained herein, the computers 1a-1n will be referred to as institutional computers and the computer system 3 will be referred to as the production computer system. Those skilled in the art will recognize that the computer system 3 (i.e., the production computer system) can be a single computer or a plurality of computers linked together as part of a network. The computers of the production computer system 3 can be at a single location or at multiple locations. The printer 4 will typically be located in the publisher's printing plant.

The present invention can be used with virtually any desktop publishing software loaded on an institutional computer 1. Desktop publishing software products commonly used today include Pagemaker® published by Adobe Systems Incorporated of San Jose, Calif. or Quark XPress® published by Quark, Inc. of Denver, Colo.

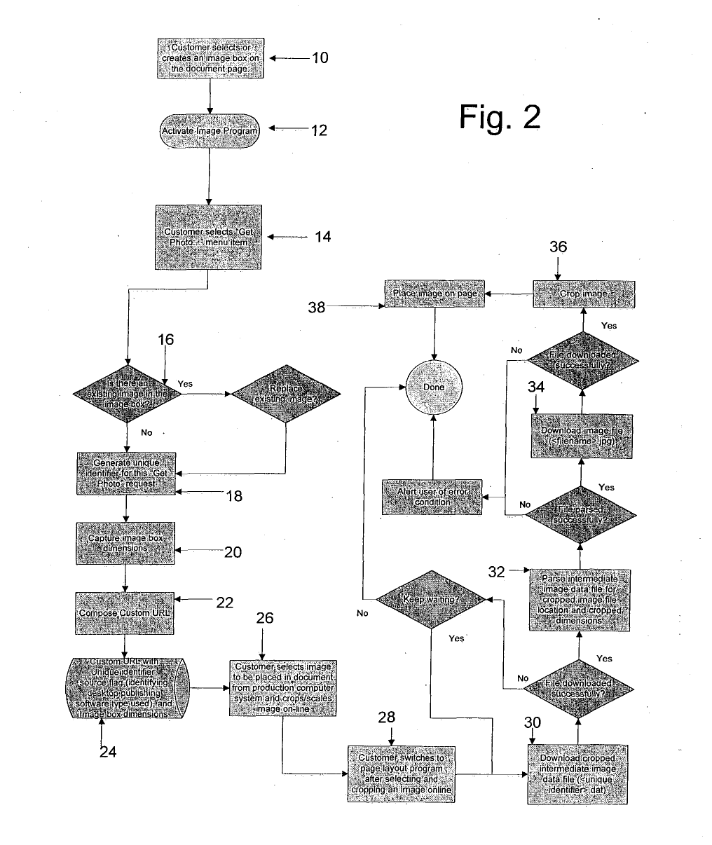

When users of the desktop publishing software products of the type loaded on institutional computer 1 wish to insert a picture or other graphic element into a page layout, the software allows a user to select or create an image box on a document page. In FIG. 2, this is indicated at step 10. The user must then identify the picture to be inserted into the image box. A small plug-in file can be installed on the institutional computer 1 that works with the desktop publishing software to automate the process of selecting and retrieving a desired image file from the production computer system 3.

When such a plug-in is provided, the user of institutional computer 1 activates the plug-in at step 12 shown in FIG. 2 and is presented with a menu at step 14 from which the user can select the option of retrieving an image file corresponding to a photograph or other graphic image from the production computer system 3.

At step 16, the institutional computer 1 checks to see if there is an image in the graphics box. If there is, the user is asked whether the image should be replaced. If there is no image in the box, or if the user indicates the image should be replaced, a unique identifier for the photo request is automatically created by institutional computer 1 at step 18. The institutional computer 1 captures the dimensions of the image box at step 20 and composes a URL at step 22. At step 24, the URL is coupled to the unique identifier, a source flag indicating the type of desktop publishing software being used, and the image box dimensions.

At step 26, the plug-in opens a communication link via the Internet between institutional computer 1 and production computer system 3. The customer, at the institutional computer, selects the image stored as a low-resolution image file on production computer system 3 to be placed in the image box on the document page and can crop, scale or otherwise edit the image on-line. After such editing of the image is complete, it is saved on the production computer system 3 using the unique identifier created in step 18.

At step 28, the customer switches back to the page layout program and the document page. Next, at step 30, the institutional computer 1 sends an instruction to production computer system 3 to download the image file as saved in step 28. This image file is parsed at step 32 to create a low-resolution version that is then transferred from production computer system 3 to institutional computer 1 via the Internet connection. Institutional Computer 1 receives the low-resolution image file at step 34. Further cropping or editing of the drawing can be performed at step 36. The image is then placed in the image box of the document page at step 38.

Further editing of the page can take place on institutional computer 1. Once a satisfactory page is completed, the file for the page layout created on institutional computer 1 can be uploaded to the production computer system 3. Alternatively, the page layout can be stored on any portable storage media and sent to the publisher. Once received by the production computer system 3, the production computer system 3 replaces any low-resolution images with high-resolution images before printing. As indicated above, any cropping, scaling or editing of the low-resolution images is automatically applied to the high-resolution image as part of this replacement step. The pages can then be printed on the printer 4.

1. A method for producing for publication pages containing images using a system that includes an institutional computer having desktop publishing software and connected to the Internet, a production computer system also connected to the Internet having a plurality of images stored thereon as high-resolution image files, and a printer connected to said production computer system, said method comprising the steps of:
a. using the institutional computer to open an image box on a document page and initiate a request for an image stored as a high-resolution image file on said production computer system, said request comprising a URL with a unique identifier;
b. selecting an image file from the plurality of high-resolution image files stored on said production-computer system and downloading from said production computer system to said institutional computer a low-resolution version of the selected image file;
c. placing said low-resolution version of the selected image file in the image box of the document page;
d. transferring to the production computer system the document page; and
e. automatically replacing said low-resolution version of the selected image file inserted into the image box of the document page with the corresponding high-resolution image file.

2. The method of claim 1 further including the step of cropping said low-resolution version.

3. The method of claim 2 wherein any cropping of said low-resolution version is retained when the low-resolution version is automatically replaced by the corresponding high-resolution image file.

4. The method of claim 1 further including the step of scaling said low-resolution version.

5. The method of claim 4 wherein any scaling of said low-resolution version is retained when the low-resolution version is automatically replaced by the corresponding high-resolution image file.

6. The method of claim 1 wherein said document page is transferred to the production computer system via the Internet.

7. The method of claim 1 further including the step of printing at least one copy of the document page after the corresponding high-resolution image file has been substituted for said low-resolution version.
